(19) United States
(12) Patent Application Publication
(10) Pub. No.: US 2026/0109561 A1
(43) Pub. Date: Apr. 23, 2026

(54) MEDIUM TRANSACTION DEVICE AND CONTROL METHOD

(71) Applicant: Oki Electric Industry Co., Ltd., Tokyo (JP)

(72) Inventors: Shinji SATOU, Tokyo (JP); Toshitaka SAITOU, Tokyo (JP)

(73) Assignee: Oki Electric Industry Co., Ltd., Tokyo (JP)

(21) Appl. No.: 18/879,130

(22) PCT Filed: Aug. 9, 2023
(86) PCT No.: PCT/JP2023/029094

§ 371 Date: Dec. 26, 2024

(30) Foreign Application Priority Data
Oct. 3, 2022 (JP) 2022-159467

(51) Int. Cl. B65H 7/12; G07D 11/13; G07D 11/237

(52) U.S. Cl. CPC B65H 7/12; G07D 11/13; G07D 11/237; B65H 2701/1912

(57) ABSTRACT

To make it possible to improve an accuracy of medium residual detection. A medium transaction device which includes a storage part that storages a medium, a vertically movable stage that is provided in the storage part and on which the medium is stacked, a conveyance roller that is provided on the upper side of the storage part to separate the medium stacked on the stage and convey the medium to a conveyance gate, a detector that detects whether or not the medium remains on the stage, a tongue piece roller with a tongue piece that knocks off the medium remaining at the conveyance gate, and a control unit that operates the tongue piece roller when the detector has not detected a residual of the medium.

### TECHNICAL FIELD

The present invention relates to a medium transaction device and a control method.

### BACKGROUND ART

Conventionally, a medium storage device managing a paper-sheet-like medium such as paper money has a function of stacking the medium and a function of feeding out and conveying the stacked medium. For example, the following Patent Literature 1 discloses the medium transaction device that increases a possibility of normally feeding out a medium released into a space where the media is stored but not stacked normally in the space by guiding the medium to be close to a residual detector or a separation release unit.

### CITATION LIST

### Patent Literature

Patent Literature 1: JP 2015-36933A

### SUMMARY OF INVENTION

### Technical Problem

However, at the time of separating the media stacked in the storage space and conveying them to the conveyance gate, a folded or broken medium may remain in the conveyance gate, and may not be detectable by the detector that detects a residual of the medium on the stage where the media is stacked. In this case, it may be erroneously determined that a medium residual is absent even though a medium remains in the storage space.

Therefore, in view of the above-described problems, the present invention aims at providing a new and improved medium transaction device and control method capable of improving an accuracy of medium residual detection.

### Solution to Problem

In order to solve the above problems, according to one aspect of the present invention, a medium transaction device which includes a storage part that storages a medium, a vertically movable stage that is provided in the storage part and on which the medium is stacked, a conveyance roller that is provided on the upper side of the storage part to separate the medium stacked on the stage and convey the medium to a conveyance gate, a detector that detects whether or not the medium remains on the stage, a tongue piece roller with a tongue piece that knocks off the medium remaining at the conveyance gate, and a control unit that operates the tongue piece roller when the detector has not detected a residual of the medium is provided.

The control unit may operate the tongue piece roller, and then cause the detector to detect again whether or not the medium remains.

The control unit may operate the tongue piece roller after or while lowering the stage to a predetermined position.

The control unit may operate the tongue piece roller, lift the stage to a separation position, and then cause the detector to detect again whether or not the medium remains.

The detector may detect whether or not the medium remains on the stage on the basis of whether or not detection light is shielded by the medium.

The medium transaction device may include as the detector, a plurality of detectors detecting different positions on the stage.

The tongue piece roller may be movable to an exposed position where the tongue piece is exposed to the conveyance gate and to a retracted position where the tongue piece is not exposed from the conveyance gate, and to operate the tongue piece roller, the control unit may move the tongue piece roller to the exposed position, and then rotate the tongue piece roller.

The control unit may lower the stage by a predetermined amount, and then move the tongue piece roller to the exposed position.

The control unit may rotate the tongue piece roller moved to the exposed position after or while further lowering the stage to a predetermined position.

The control unit may operate the tongue piece roller, move the tongue piece roller to the retracted position, lift the stage, and then cause the detector to detect again whether or not the medium remains.

The tongue piece roller may be a tongue piece roller with the tongue piece provided partially, and the control unit may stop the tongue piece roller at a retracted angle where the tongue piece is not exposed to the conveyance gate to separate the medium stacked on the stage by the conveyance roller, and rotate the tongue piece roller to operate the tongue piece roller.

The control unit may operate the tongue piece roller, and then perform a predetermined number of times a series of operations for detection by the detector.

In order to solve the above problems, according to another aspect of the present invention, a control method, causing a processor to perform separating a medium stacked on a vertically movable stage in a storage part storing the medium and conveying the medium to a conveyance gate by a conveyance roller provided on the upper side of the storage part detecting whether or not the medium remains on the stage, and operating, when a residual of the medium has not been detected, a tongue piece roller with a tongue piece that knocks off the medium remaining at the conveyance gate is provided.

### Advantageous Effects of Invention

As is described above, in the present invention, it is possible to improve an accuracy of medium residual detection.

### BRIEF DESCRIPTION OF DRAWINGS

FIG. 1 is a block diagram illustrating an example of a configuration of an automatic transaction device 1 according to the embodiment.

FIG. 2 is a schematic view illustrating an inner configuration of a paper money storage part 142 according to the embodiment.

FIG. 3 is a schematic view illustrating an inner configuration of the paper money storage part 142 when the paper money storage part 142 illustrated in FIG. 2 is viewed from the right direction.

FIG. 4 is a diagram illustrating a state in which all paper money is fed out from the paper money storage part 142.

FIG. 5 is a diagram for explaining a case where a residual of abnormal paper money is not detected.

FIG. 6 is a diagram for explaining the details of paper money residual detection control according to the embodiment.

FIG. 7 is a diagram for explaining the details of paper money residual detection control according to the embodiment.

FIG. 8 is a diagram for explaining the details of paper money residual detection control according to the embodiment.

FIG. 9 is a diagram for explaining the details of paper money residual detection control according to the embodiment.

FIG. 10 is a flowchart illustrating a flow of operation processing of paper money residual detection control according to the embodiment.

FIG. 11 is a diagram for explaining a modification of the embodiment.

FIG. 12 is a block diagram illustrating an example of a hardware configuration of an information processing apparatus 900 according to the embodiment.

### DESCRIPTION OF EMBODIMENTS

Hereinafter, preferred embodiments of the present invention will be described in detail with reference to the appended drawings. It should be noted that, in this specification and the drawings, structural elements that have substantially the same function and structure are denoted with the same reference signs, and repeated explanation thereof is omitted.

### «1. Overview»

The present embodiment mainly relates to a mechanism for reducing erroneous determination of paper money residual detection by the paper money storage part provided in the automatic transaction device.

The automatic transaction device is a device installed in a financial institution, commercial facility, retail store, or the like to manage the reception and payment of cash including at least paper money. Further, the automatic transaction device is an example of the medium transaction device.

### <1-1. Configuration of Automatic Transaction Device 1>

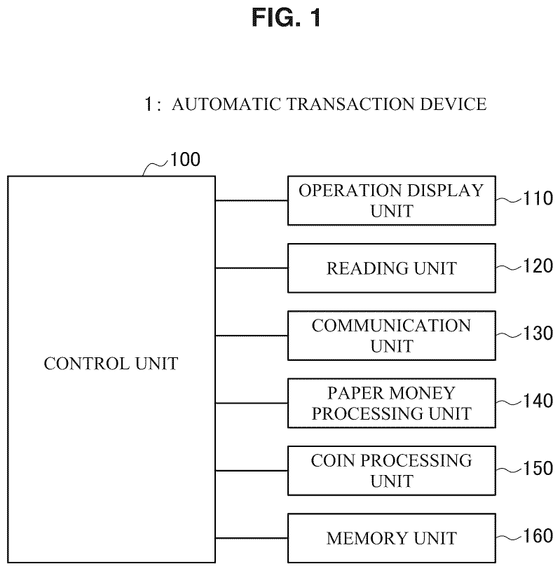

FIG. 1 is a block diagram illustrating an example of the configuration of an automatic transaction device 1 according to the embodiment. As illustrated in FIG. 1, the automatic transaction device 1 includes a control unit 100, an operation display unit 110, a reading unit 120, a communication unit 130, a paper money processing unit 140, a coin processing unit 150, and a memory unit 160.

The control unit 100 is mainly formed by, for example, a central processing unit (CPU), a random access memory (RAM), and the like, and controls each functional unit of the automatic transaction device 1 to execute various transactions (reception transaction, payment transaction, cash replenishment transaction, collection transaction, and the like). Further, the control unit 100 controls the memory unit 160 to store the history of each transaction.

The operation display unit 110 includes the functions as a display unit that displays a menu screen, a guidance screen, an operation guidance screen, and the like for various transactions, and as an input unit for customers to perform operation input. The function as the display unit is realized by, for example, a cathode ray tube (CRT) display device, a liquid crystal display (LCD) device, or an organic light emitting diode (OLED) device. Further, the function as the input unit is realized by, for example, a touch panel. The functions of the display unit and the input unit may be configured integrally or configured separately.

The reading unit 120 has a function of optically reading information printed on a paper medium such as a receipt. It may also be assumed that the information printed on a paper medium is printed out by encoded information such as a one-dimensional barcode or a QR code (registered trademark). The reading unit 120 may be realized by, for example, a camera or a barcode reader.

The communication unit 130 transmits and receives data to and from the upper PC via a dedicated network (LAN or the like), for example. For example, the communication unit 130 transmits the totaled sales proceeds information to the upper PC when a closing transaction is performed.

The paper money processing unit 140 performs paper money reception processing and paper money payment processing. Specifically, the paper money processing unit 140 includes a paper money reception/payment port, a paper money temporary holding part, a paper money discrimination part, and a paper money cassette (an example of a paper money storage part). The paper money reception/payment port functions as an insertion port for inserting paper money, a payment port for withdrawing paper money in payment transaction, and a return port for returning received paper money. The paper money temporary holding part temporarily stacks paper money at the time of counting the paper money received. The paper money discrimination part discriminates the authenticity, denomination, soundness, and the like of the paper money inserted. The paper money discrimination part is also a count part that counts the paper money inserted. The paper money cassette includes a cassette for storing paper money by denomination (for example, a 10,000-ticket cassette, a 5,000-ticket cassette, and a 1,000-ticket cassette), and a collection cassette. Further, the paper money processing unit 140 includes therein a conveyance path for conveying paper money. The conveyance path conveys cash received from the paper money reception/payment port to the paper money discrimination part, conveys paper money having passed through the paper money discrimination part to the paper money temporary holding part, and conveys paper money stacked in the paper money temporary holding part to the paper money cassette, for example. The paper money processing unit 140 having such a configuration performs reception processing of paper money inserted from the paper money reception/payment port, and payment processing of paper money to the paper money reception/payment port.

The coin processing unit 150 performs coin reception processing and coin payment processing. Specifically, the coin processing unit 150 includes a coin insertion port, a coin discrimination part, a coin temporary holding part, a coin return box, a payment hopper, a coin payment box, and a coin collection storage. The coin insertion port is a port for an operator to insert coins. The coin discrimination part discriminates the authenticity, denomination, soundness, and the like of the coin inserted. The coin discrimination part is also a count part that counts the coin inserted. Further, the coin processing unit 150 includes therein a conveyance path for conveying coins. The conveyance path conveys cash received from the coin insertion port to the coin discrimination part, and conveys coins having passed through the coin discrimination part to the coin temporary holding part. The coin processing unit 150 having such a configuration performs reception processing of coins inserted from the coin insertion port, and payment processing of coins to the coin payment box or the like.

The memory unit 160 is realized by a read only memory (ROM), a random access memory (RAM), or the like, and stores a control program for controlling the operations of the automatic transaction device 1, input data at the time of transaction of the automatic transaction device 1, display screens, and the like. Further, the memory unit 160 stores the contents of each transaction performed by the automatic transaction device 1 in accordance with the control of the control unit 100.

The above has described a configuration example of the automatic transaction device 1. Note that the configuration of the automatic transaction device 1 is not limited to the example illustrated in FIG. 1. For example, the automatic transaction device 1 may further include a card reader unit that reads user information from an ID card, an IC card, or the like, a biometric reading unit that reads the user's biological information, a password input unit that accepts password input such as a keypad, a receipt printer unit that prints and issues a transaction result on a paper medium (for example, a receipt), and the like. Further, the automatic transaction device 1 may not include the reading unit 120, the communication unit 130, and the coin processing unit 150, for example.

### <1-2. Regarding Paper Money Storage Part>

Here, the automatic transaction device 1 is mainly formed by a box-shaped housing, and the front surface of the housing facing a user includes the operation display unit 110, the reading unit 120, the paper money reception/payment port, the coin insertion port, and the like. Further, the housing includes therein the control unit 100, the communication unit 130, the paper money processing unit 140, the coin processing unit 150, and the memory unit 160.

The paper money processing unit 140 includes the paper money cassette (paper money storage part) that is an example of a storage unit that stores media. At the time of reception transaction, the paper money processing unit 140 stacks the received paper money in the paper money cassette, while at the time of payment transaction, the paper money processing unit 140 separates the paper money one by one from the paper money cassette for payment. Hereinafter, the internal configuration of the paper money storage part will be described with reference to the drawings.

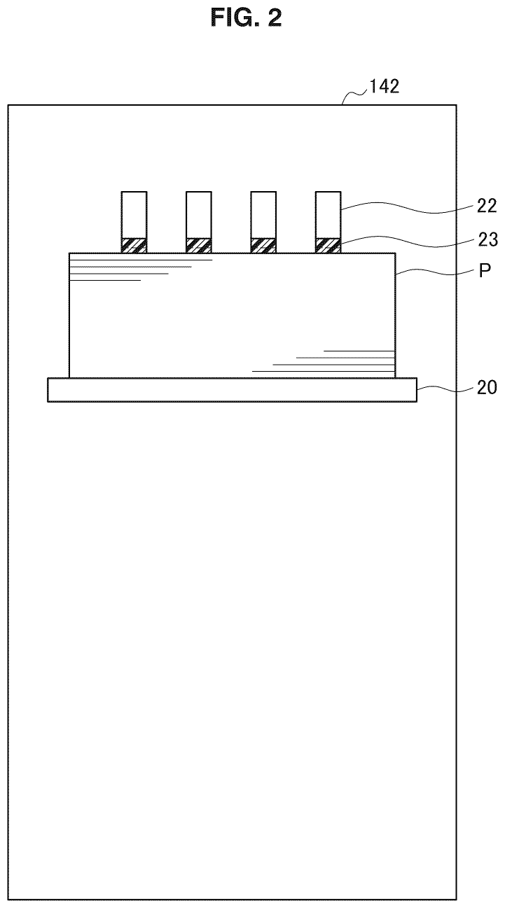

FIG. 2 is a schematic view illustrating an inner configuration of the paper money storage part 142 according to the embodiment. As illustrated in FIG. 2, the paper money storage part 142 includes therein a stage 20 in which paper money P is stacked and that is vertically movable. Further, the paper money storage part 142 includes, on the upper side therein, a picker roller 22 that presses the uppermost paper money P stacked on the stage 20. The picker roller 22 is a conveyance roller that conveys paper money. The number of picker rollers 22 is not particularly limited. In a part of the outer peripheral surface of the picker roller 22, a high friction member 23 having a large friction coefficient, such as rubber, is attached so that the paper money P is easily separated and fed out.

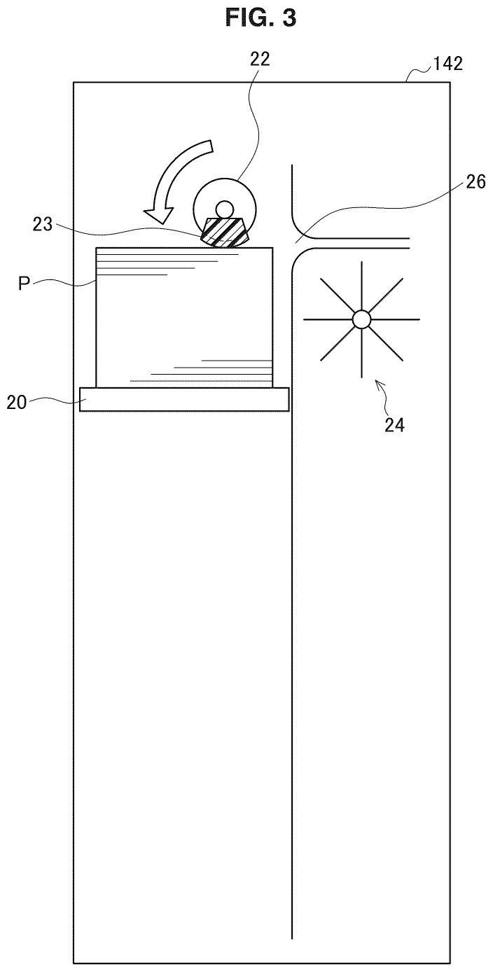

FIG. 3 is a schematic view illustrating an inner configuration of the paper money storage part 142 when the paper money storage part 142 illustrated in FIG. 2 is viewed from the right direction. As illustrated in FIG. 3, the paper money P is stacked on the stage 20. To separate and feed out paper money, the control unit 100 lifts the stage 20 and rotates the picker roller 22 in the illustrated direction while pressing the stacked paper money against the picker roller 22, whereby it is possible to separate the uppermost paper money from the stacked paper money and feed it out to the conveyance gate 26 that is an inlet of the conveyance path. The paper money fed out to the conveyance gate 26 can be conveyed by a pair of conveyance rollers (not illustrated) provided in the conveyance path.

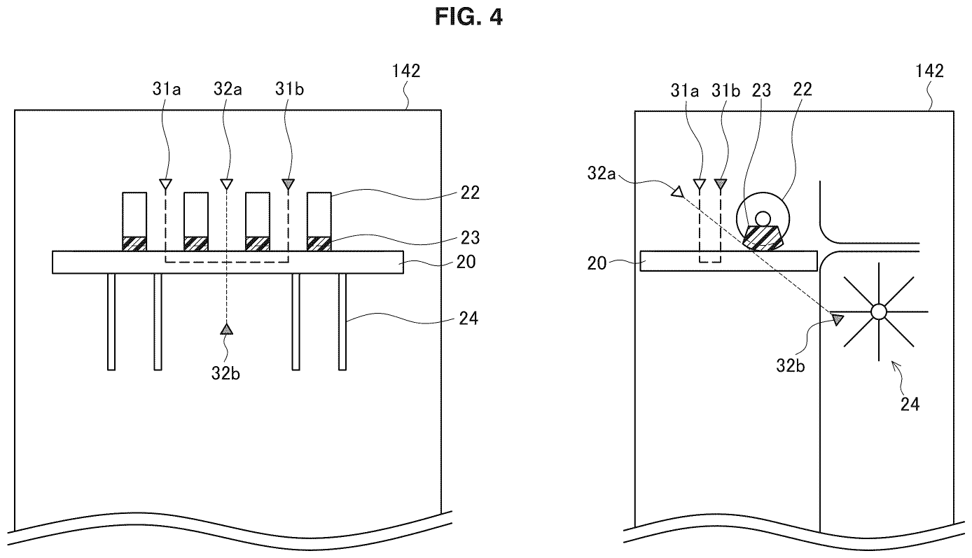

FIG. 4 is a diagram illustrating a state in which all paper money is fed out from the paper money storage part 142. The left side of FIG. 4 illustrates a front view of the paper money storage part 142, and the right side of FIG. 4 illustrates a right side view of the paper money storage part 142. As illustrated in FIG. 4, the stage 20 includes a residual detector 31 (a light emitting portion 31a and a light receiving portion 31b) and a residual detector 32 (a light emitting portion 32a and a light receiving portion 32b) as detectors that detect whether or not paper money remains on the stage 20. The stage 20 includes passing holes through which each detection light emitted from the light emitting portions 31a, 31b passes. In a case where one or more sheets of paper money are placed on the stage 20, the detection light is shielded by the paper money, thereby disabling the light reception by the light receiving portions 31b, 32b. Each light receiving portion 31b, 32b outputs a light reception result of whether or not the detection light has been received to the control unit 100.

The control unit 100 determines the presence or absence of paper money on the stage 20 on the basis of whether or not the light receiving portions 31b, 32b have received the detection light. The residual detector 31 and the residual detector 32 are arranged to detect different positions on the stage 20. The number and arrangement of residual detectors are not limited to the example illustrated in FIG. 4. When either the residual detector 31 or the residual detector 32 has not detected paper money residual (specifically, in a case where the light receiving portions 31b, 32b have received detection light), the control unit 100 determines the absence of a paper money residual, that is, the state of the paper money end (the paper money storage part 142 is empty). The control unit 100 may notify the upper PC of the paper money end.

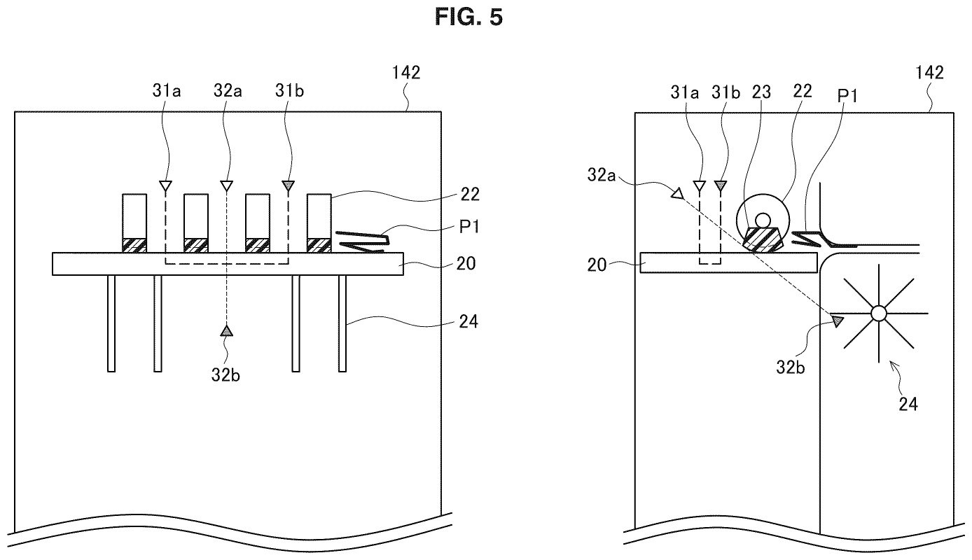

However, if the paper money to be separated and fed out is folded or broken and remains at a position where the detection light is not shielded, such as at the edge of the conveyance gate 26, the residual detectors 31, 32 may not detect the paper money residual. FIG. 5 is a diagram for explaining a case where a residual of abnormal paper money is not detected. As illustrated in FIG. 5, when the abnormal paper money P1 is positioned at a place where any detection light emitted from either the light emitting portion 31a or the light emitting portion 32a is not shielded, any of the light receiving portion 31b and the light receiving portion 32b receives detection light. Specifically, it is assumed that the abnormal paper money P1 is positioned at the end in the longitudinal direction of the conveyance gate 26 located on the back surface of the stage 20, as illustrated on the left side of FIG. 5, for example. Because any detection light is not shielded, the control unit 100 erroneously determines the “absence of a paper money residual” even though the paper money remains in the paper money storage part 142, and notifies the upper PC of the paper money end, which may cause mistakes in cash calculation.

In view of the above-described problem, the present invention aims at improving the accuracy of residual medium detection.

The following will describe the details of the paper money residual detection control according to the embodiment.

### «2. Paper Money Residual Detection Control»

Even in a case where the separation and feeding of paper money from the paper money storage part 142 is completed and the paper money end is detected, abnormal paper money may remain at the end of the conveyance gate 26 or the like, as described above. In the present embodiment, it is possible to reduce erroneous determination of the absence of a medium residual by a predetermined control performed when the paper money end has been detected. More specifically, when the residual detectors have not detected a paper money residual, the control unit 100 operates a tongue piece roller with a tongue piece that knocks off the paper money remaining at the conveyance gate 26, and cause the residual detectors to detect a paper money residual again.

The tongue piece roller is an impeller-shaped roller having a plurality of tongue pieces radially extending from the outer peripheral surface of a cylindrical connecting member (for example, a hub portion) provided on a drive shaft (also a rotation axis). The tongue piece can be formed using an elastic material such as natural rubber or synthetic rubber. FIG. 3 to FIG. 5 illustrate a state in which the tongue piece roller 24 is retracted to a position where the tongue pieces are not exposed to the conveyance gate 26. As illustrated in FIG. 4, four tongue piece rollers 24 are provided in the longitudinal direction of the conveyance gate 26, but the number of tongue piece rollers 24 is not particularly limited.

With a mechanism not illustrated, the tongue piece roller 24 is movable to an exposed position where the tongue pieces are exposed to the conveyance gate 26. When the paper money is stacked in the paper money storage part 142, the tongue piece roller 24 may move to the exposed position by the control of the control unit 100, and rotate counterclockwise so as to knock off the rear end of the paper money that is released from the conveyance gate 26 into the paper money storage part 142 (into the storage space).

In the present embodiment, the tongue piece roller 24 used at the time of stacking paper money in this way is also used for paper money residual detection control at the time of separating the paper money, whereby it is possible to reduce erroneous determination of the absence of a medium residual without changing the components.

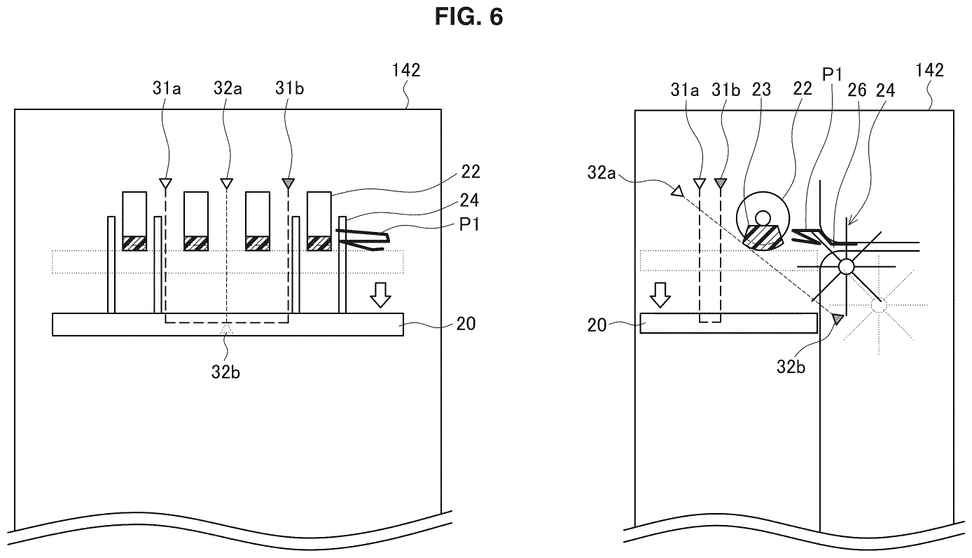

FIG. 6 to FIG. 9 are diagrams for explaining the details of paper money residual detection control according to the embodiment. The left side of each drawing illustrates a front view of the paper money storage part 142, and the right side of each drawing illustrates a right side view of the paper money storage part 142. First, as illustrated in FIG. 6, when the detection light is not shielded despite the presence of the abnormal paper money P1, and both the residual detectors 31, 32 have detected the paper money end (absence of residual paper money), the control unit 100 lowers the stage 20 by a specified amount, secures a space where the tongue pieces are exposed, and moves the tongue piece roller 24 to the exposed position. Note that the present invention is not limited thereto if the tongue piece roller 24 can be moved to the exposed position without lowering the stage 20 by a specified amount.

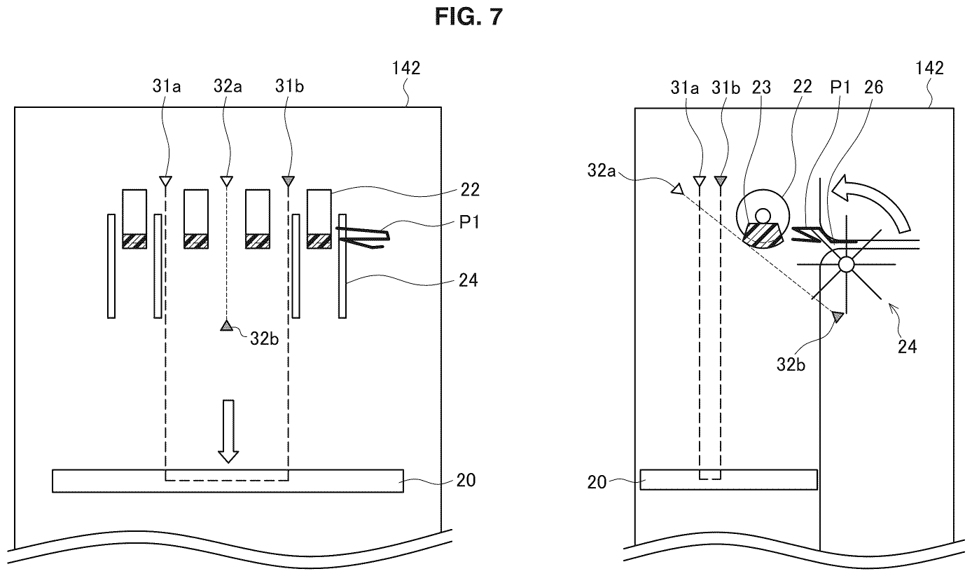

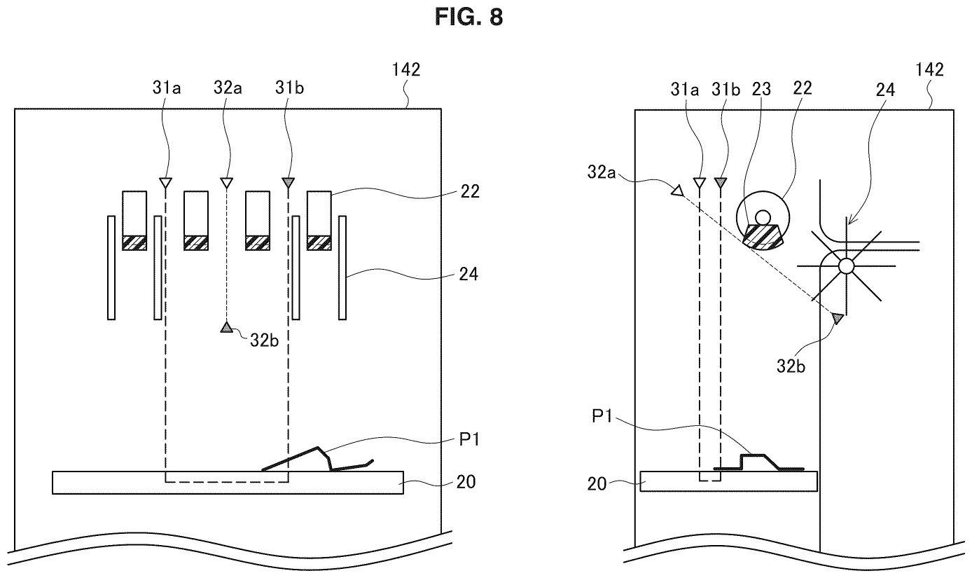

Next, as illustrated in FIG. 7, the control unit 100 rotates the tongue piece roller 24 counterclockwise after or while lowering the stage 20 to a predetermined position, so that the abnormal paper money P1 can be knocked off onto the stage 20, as illustrated in FIG. 8. The number and arrangement of tongue piece rollers 24 are not particularly limited, but as illustrated on the left side of FIG. 7, for example, four tongue piece rollers 24 are provided in the longitudinal direction of the paper money storage part 142. With the plurality of tongue piece rollers 24 that are provided at least both ends in the longitudinal direction of the conveyance gate 26 not illustrated on the left side of FIG. 7, it is possible to knock off the abnormal paper money P1 caught at the end of the conveyance gate 26. The number of rotations of the tongue piece roller 24 is not particularly limited. The control unit 100 may rotate the tongue piece roller 24 a predetermined number of times or a predetermined time.

The above-described predetermined position at the time of lowering the stage 20 only needs to be a position that secures at least a distance with which the paper money to be knocked off can fall to a position on the stage where the detection light emitted from the light emitting portions 31a, 31b is shielded. Such a position may be, for example, a stacking position. The stacking position is the lowest position to which the stage 20 can be lowered.

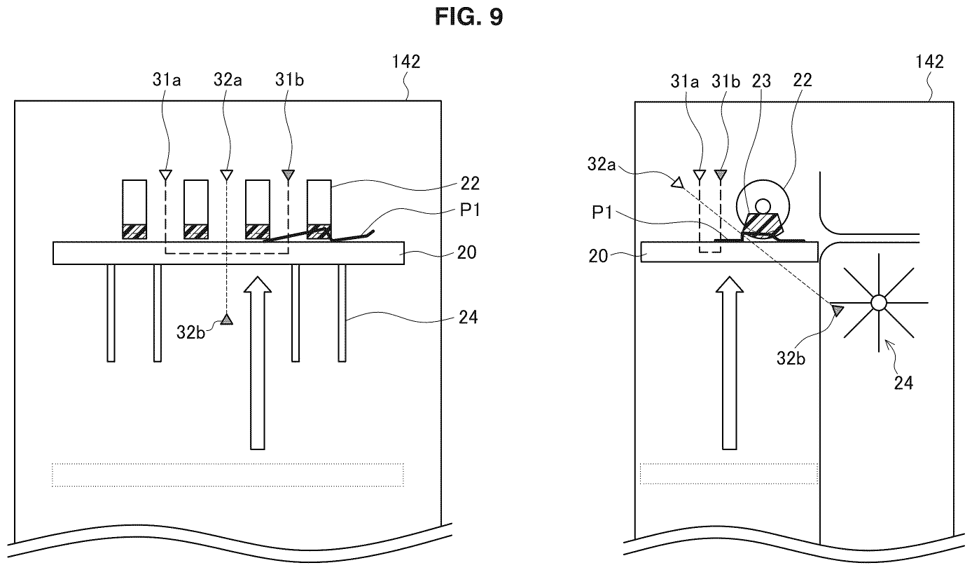

Subsequently, as illustrated in FIG. 9, the control unit 100 moves the tongue piece roller 24 to the retracted position, and then performs a control of lifting the stage 20 to a separation position. The separation position is a position at which the paper money P can be separated and fed out, that is, a position at which the paper money P is pressed by the picker roller 22. In the example illustrated in FIG. 9, the separation position is the highest position to which the stage 20 can be lifted. Then, the control unit 100 performs paper money residual detection again by the residual detector 31 and the residual detector 32. Here, as illustrated in FIG. 9, when at least any of the detection light emitted from the light emitting portion 31a and the light emitting portion 32a is shielded by the abnormal paper money P1, the control unit 100 is able to correctly determine that the paper money remains. The control unit 100 notifies the upper PC of the paper money residual, thus preventing mistakes in cash calculation. Note that the control unit 100 may determine the “residual of abnormal paper money” and notify the upper PC of the occurrence of abnormal paper money.

### (Operation Processing)

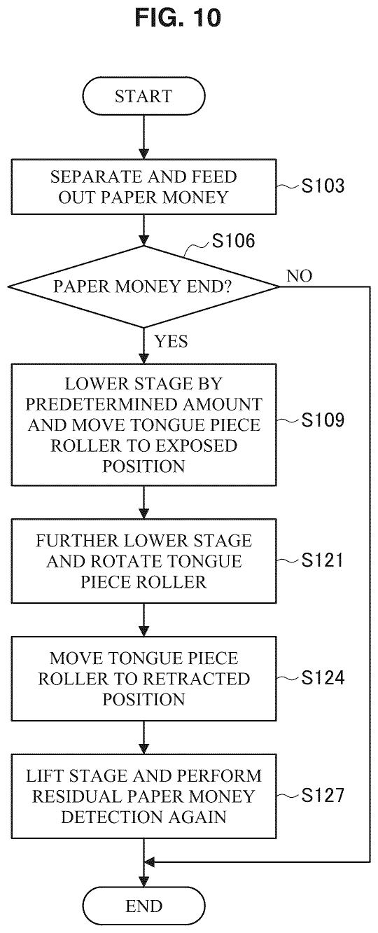

FIG. 10 is a flowchart illustrating a flow of operation processing of paper money residual detection control according to the embodiment.

As illustrated in FIG. 10, the control unit 100 first separates and feeds out the paper money from the paper money storage part 142 (Step S103). Specifically, the control unit 100 lifts the stage 20, presses the uppermost paper money stacked on the stage 20 against the picker roller 22, and rotates the picker roller 22 to convey the uppermost paper money to the conveyance gate 26.

Next, the control unit 100 determines whether or not the paper money end (that is, the absence of residual paper money) has been detected on the basis of the detection results from the residual detector 31 and the residual detector 32 (specifically, the reception results of the detection light at the light receiving portions 31b, 32b) (Step S106). The control unit 100 performs residual detection each time the number of sheets of paper money for payment is separated and fed out. When the paper money end has not been detected (No at Step S106), the control unit 100 finishes the operation.

Next, when the paper money end has been detected (Yes at Step S106), the control unit 100 lowers the stage 20 by a predetermined amount, and then moves the tongue piece roller 24 to the exposed position where the tongue pieces are exposed to the conveyance gate 26 (step S109).

Next, the control unit 100 further lowers the stage 20, and rotates the tongue piece roller 24 (Step S121). As a result, the abnormal paper money that were not detectable by either the residual detector 31 or the residual detector 32 may be knocked off onto the stage 20 by a tongue piece.

Subsequently, the control unit 100 moves the tongue piece roller 24 to the retracted position where the tongue pieces are not exposed to the conveyance gate 26 (Step S124).

Then, the control unit 100 lifts the stage 20 to the separation position, and then performs residual paper money detection again (Step S127). As described above, if the abnormal paper money that were not detectable by either the residual detector 31 or the residual detector 32 is knocked off onto the stage 20 by a tongue piece, the residual paper money can be detected.

The above has described one example of the operation processing of paper money residual detection control according to the embodiment. Note that the control unit 100 may repeat the processing shown in Steps S106 to S127 illustrated in FIG. 10 a predetermined number of times. That is, when the residual paper money is not detected at Step S127, the processing shown in Steps S109 to S127 may be performed again. Further, the control unit 100 may perform the paper money residual detection shown in Step S127 after lowering the stage 20, rotating the tongue piece roller 24, and lifting the stage 20 a predetermined number of times.

Further, in the above-described embodiment, the tongue piece roller 24 used at the time of stacking paper money is also used at the time of separating the paper money, but the present embodiment is not limited thereto. The tongue piece roller 24 may have a configuration used only for the paper money residual detection control according to the embodiment.

Further, in the above-described embodiment, the tongue piece roller 24 is rotated after or while lowering the stage 20 to a predetermined position, but the present embodiment is not limited thereto. For example, in a case where a stacking space is secured on the stage 20 without lowering the stage 20, the control unit 100 may rotate the tongue piece roller 24 without lowering the stage 20. The case where a stacking space is secured is assumed to be a case where a predetermined distance is secured between the conveyance gate 26 and the stage 20. The predetermined distance may be, for example, a distance with which the posture of the paper money knocked off by a tongue piece can change, and can be set again.

### «3. Modification»

The following will describe a modification of the embodiment. In the above-described embodiment, the tongue piece roller 24 with a plurality of tongue pieces provided radially at equal intervals is used, and as an operation of the tongue piece roller 24, the tongue piece roller 24 is moved from the retracted position to the exposed position and then rotated. However, the shape and operation of the tongue piece roller according to the present invention is not limited thereto.

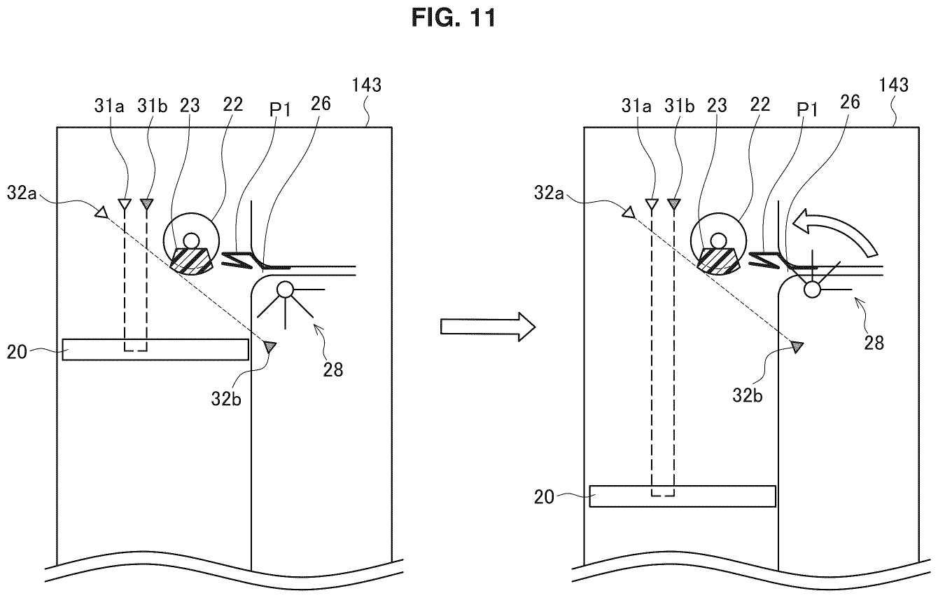

FIG. 11 is a diagram for explaining a modification of the embodiment. As illustrated in FIG. 11, the paper money storage part 143 according to the modification includes a partial tongue piece roller 28 with a plurality of tongue pieces provided partially. The control unit 100 can perform a control of stopping the rotation angle of the partial tongue piece roller 28 at an angle where the tongue pieces are not exposed to the conveyance gate 26 (retracted angle), as illustrated on the left side of FIG. 11, and a control of rotating the partial tongue piece roller 28 in the illustrated direction (counterclockwise), as illustrated on the right side of FIG. 11. The control unit 100 first stops the partial tongue piece roller 28 in the state illustrated in FIG. 11 (retracted state), thereby preventing the tongue pieces from interfering with the conveyance of paper money at the time of separating and feeding out the paper money stacked on the stage 20, for example. Next, in the paper money residual detection control after separation and feeding, as illustrated on the right side of FIG. 11, the partial tongue piece roller 28 is rotated to expose the tongue pieces to the conveyance gate 26 and knock off the abnormal paper money P1. To rotate the partial tongue piece roller 28, the control unit 100 may preliminarily lower the stage 20 to secure a stacking space.

In this way, using the partial tongue piece roller 28 with a plurality of tongue pieces provided partially, the control unit 100 can control the retraction and exposure of the tongue pieces without providing a mechanism for moving the tongue piece roller.

«4. Hardware Configuration Example»The following will describe a hardware configuration of the automatic transaction device 1 according to the embodiment. The above-described operation is realized by the cooperation of software and hardware described below.

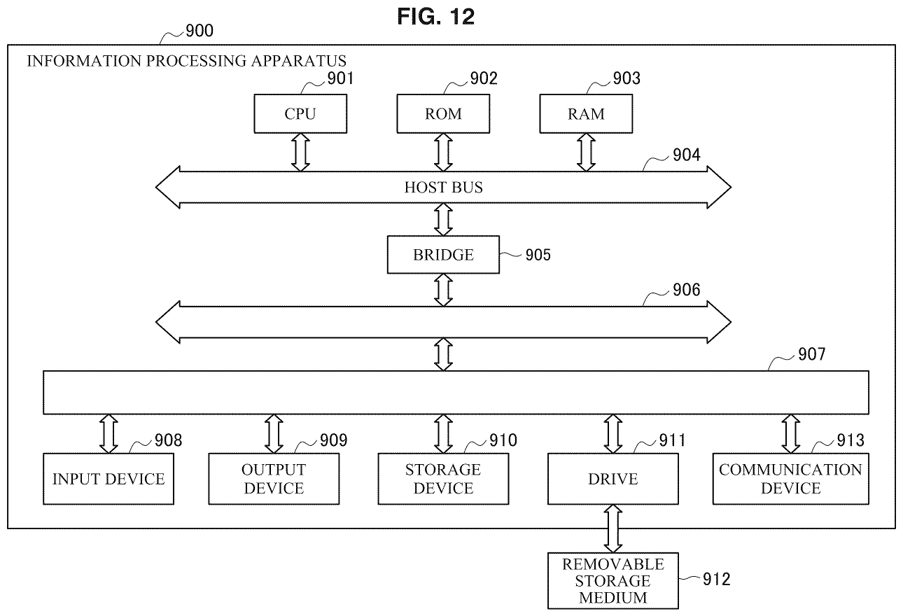

FIG. 12 is a block diagram illustrating an example of the hardware configuration of the information processing apparatus 900 according to the embodiment. The information processing apparatus 900 is an example of the hardware configuration applied to automatic transaction device 1 according to the embodiment.

The information processing apparatus 900 includes a central processing unit (CPU) 901, a read only memory (ROM) 902, a random access memory (RAM) 903, a host bus 904, a bridge 905, an external bus 906, an interface 907, an input device 908, an output device 909, a storage device 910, a drive 911, and a communication device 913.

The CPU 901 functions as an arithmetic processing device and a control device, and controls the overall operations in the information processing apparatus 900 in accordance with various programs. Further, the CPU 901 may be a microprocessor. The ROM 902 stores programs, operation parameters, and the like used by the CPU 901. The RAM 903 temporarily stores programs used in the execution of the CPU 901, parameters that change appropriately in the execution of the programs, and the like. These are mutually connected by the host bus 904 formed by a CPU bus or the like. With the cooperation of the CPU 901, ROM 902, and RAM 903, the control unit 100 of the automatic transaction device 1 is realized.

The host bus 904 is connected to the external bus 906 such as a peripheral component interconnect/interface (PCI) bus via the bridge 905. Note that it is not necessarily required to configure the host bus 904, the bridge 905, and the external bus 906 separately, and these functions may be implemented on one bus.

The input device 908 includes input means for an operator to input information, such as a mouse, keyboard, touch panel, button, switch, or microphone, an input control circuit for generating an input signal on the basis of the input by the operator and outputting it to the CPU 901, and the like. With the operation on the input device 908, the operator who operates the information processing apparatus 900 is able to input various kinds of data to the information processing apparatus 900, or instruct the information processing apparatus 900 to perform processing operation. The input device 908 realizes the input function of the operation display unit 110 of the automatic transaction device 1.

Examples of the output device 909 include, for example, a cathode ray tube (CRT) display device, a liquid crystal display (LCD) device, an organic light emitting diode (OLED) device, a display device such as a lamp, and an audio output device such as a speaker. The output device 909 realizes the display function of the operation display unit 110 of the automatic transaction device 1.

The storage device 910 is a device for storing data. The storage device 910 may include a storage medium, a recording device that records data on a storage medium, a reading device that reads data from a storage medium, a deletion device that deletes data recorded on a storage medium, and the like. The storage device 910 realizes the memory unit 160 of the automatic transaction device 1.

The drive 911 is a storage medium reader/writer, and is attached externally to the information processing apparatus 900. The drive 911 reads the information recorded in a removable storage medium 912 attached such as a magnetic disk, optical disk, magneto-optical disk, or semiconductor memory, and outputs it to the RAM 903. Further, the drive 911 is also able to write information into the removable storage medium 912.

The communication device 913 is a communication interface formed by a communication device for communication, or the like. Such a communication device 913 realizes the communication unit 130 of the automatic transaction device 1.

Note that the hardware configuration of the information processing apparatus 900 is not limited to the configuration illustrated in FIG. 12. For example, in a case where the information processing apparatus 900 performs communication through an external communication device connected thereto, it may not include the communication device 913. Further, the information processing apparatus 900 may not include, for example, the input device 908, the output device 909, or the like. Further, for example, a part or all of the configuration illustrated in FIG. 12 may be realized by one or more integrated circuits (ICs).

### «5. Supplement»

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

For example, the paper money storage part 142 according to the above-described embodiment assumes each paper money cassette that stores paper money by denomination. However, the present invention is not limited thereto, and the paper money storage part 142 may be, for example, a paper money temporary holding part that temporarily stacks paper money at the time of counting the paper money received.

Further, the automatic transaction device 1 is an example of the medium transaction device. The above-described paper money is an example of the medium. Further, the paper money processing unit 140 including a controller that controls the entire paper money processing unit 140 may be an example of the medium transaction device.

Further, one or more computer programs for exerting the functions of the automatic transaction device 1 can be formed in hardware such as the CPU, ROM, and RAM built in the automatic transaction device 1. Further, a computer readable storage medium on which the one or more computer programs are stored is also provided.

### REFERENCE SIGNS LIST

1 automatic transaction device
100 control unit
110 operation display unit
120 reading unit
130 communication unit
140 paper money processing unit
142 paper money storage part
150 coin processing unit
160 memory unit
142 paper money storage part
20 stage
22 picker roller
24 tongue piece roller
26 conveyance gate
28 partial tongue piece roller
31,32 residual detector
31a, 32a light emitting portion
31b, 32blight receiving portion
P paper money

1. A medium transaction device, comprising:
a storage part that storages a medium;
a vertically movable stage that is provided in the storage part and on which the medium is stacked;
a conveyance roller that is provided on the upper side of the storage part to separate the medium stacked on the stage and convey the medium to a conveyance gate;
a detector that detects whether or not the medium remains on the stage;
a tongue piece roller with a tongue piece that knocks off the medium remaining at the conveyance gate; and
a control unit that operates the tongue piece roller when the detector has not detected a residual of the medium.

2. The medium transaction device according to claim 1, wherein the control unit operates the tongue piece roller, and then causes the detector to detect again whether or not the medium remains.

3. The medium transaction device according to claim 1, wherein the control unit operates the tongue piece roller after or while lowering the stage to a predetermined position.

4. The medium transaction device according to claim 3, wherein the control unit operates the tongue piece roller, lifts the stage to a separation position, and then causes the detector to detect again whether or not the medium remains.

5. The medium transaction device according to claim 1, wherein the detector detects whether or not the medium remains on the stage on the basis of whether or not detection light is shielded by the medium.

6. The medium transaction device according to claim 5, comprising:
as the detector, a plurality of detectors detecting different positions on the stage.

7. The medium transaction device according to claim 1, wherein the tongue piece roller is movable to an exposed position where the tongue piece is exposed to the conveyance gate and to a retracted position where the tongue piece is not exposed from the conveyance gate, and
to operate the tongue piece roller, the control unit moves the tongue piece roller to the exposed position, and then rotates the tongue piece roller.

8. The medium transaction device according to claim 7, wherein the control unit lowers the stage by a predetermined amount, and then moves the tongue piece roller to the exposed position.

9. The medium transaction device according to claim 8, wherein the control unit rotates the tongue piece roller moved to the exposed position after or while further lowering the stage to a predetermined position.

10. The medium transaction device according to claim 7, wherein the control unit operates the tongue piece roller, moves the tongue piece roller to the retracted position, lifts the stage, and then causes the detector to detect again whether or not the medium remains.

11. The medium transaction device according to claim 1, wherein
the tongue piece roller is a tongue piece roller with the tongue piece provided partially, and
the control unit
stops the tongue piece roller at a retracted angle where the tongue piece is not exposed to the conveyance gate to separate the medium stacked on the stage by the conveyance roller, and
rotates the tongue piece roller to operate the tongue piece roller.

12. The medium transaction device according to claim 1, wherein the control unit operates the tongue piece roller, and then performs a predetermined number of times a series of operations for detection by the detector.

13. A control method, causing a processor to perform:
separating a medium stacked on a vertically movable stage in a storage part storing the medium and conveying the medium to a conveyance gate by a conveyance roller provided on the upper side of the storage part;
detecting whether or not the medium remains on the stage; and
operating, when a residual of the medium has not been detected, a tongue piece roller with a tongue piece that knocks off the medium remaining at the conveyance gate.
